(19) United States
(12) Patent Application Publication
(10) Pub. No.: US 2013/0117946 A1
(43) Pub. Date: May 16, 2013

(54) Compositions and methods to use them to remove stains from garments including water sensitive protein fibers, without incurring any damage to the fibers or dye/color loss, in wet and dry cleaning processes

(71) Applicant: Fariborz Dawudian, Paris (FR)

(72) Inventor: Fariborz Dawudian, Paris (FR)

(21) Appl. No.: 12/439,312

(22) PCT Filed: Feb. 25, 2009
(86) PCT No.: PCT/IB09/05301

§ 371 Date: Feb. 4, 2013

(51) Int. Cl. C11D 3/20; C11D 1/83

(52) U.S. Cl. CPC C11D 3/201; C11D 1/83
USPC 8/142; 8/137; 510/282; 510/284

(57) ABSTRACT

The present invention proposes compositions and methods to use for the removal of stains and particularly of those that are notoriously difficult to remove such as deodorant, perspiration and ink stains from all kinds of garments, including water sensitive protein fibers such as wool, cashmere or silk without incurring surface damage or dye/color loss. The compositions of the present invention are preferentially applied as spot cleaning compositions to the stained area of garments without scrubbing before a unique cleaning cycle at low temperature in professional wet- or dry cleaning process or a regular household laundry cycle.

### BACKGROUND OF THE INVENTION

The present invention relates to compositions and methods to efficiently remove stains, particularly deodorant, perspiration and ink stains from all kinds of garments, including water sensitive protein fibers such as wool, cashmere or silk without incurring surface damage or dye/color loss. The present invention allows, after prespotting of the garments with the compositions of the present invention, to subsequently clean the garments, including sensitive ones, at low temperature in one cycle cleaning process either in a professional wet- or dry cleaning or in a household process.

Cleaning in the clothing cleaning industry can be divided into wet cleaning and dry cleaning.

The wet cleaning process in a professional wet cleaning operation is similar to washing garments in a modern household washing machine, albeit in a controlled environment with regard to speed, temperature and water volume. Wet cleaning is a non-toxic, environmentally safe cleaning process, utilizing computer-controlled washing machines, biodegradable soaps and conditioners, and various types of pressing equipment that may be specialized for many different fabric and fiber types. Water is used as a solvent instead of organic solvents in dry cleaning. Water usage offers several advantages:
Approximately 98% of all stains are water-soluble or can be carried away by water.
Water is able to clean almost all textiles and leathers except certain textiles with water-soluble coatings.
The cleaning quality of water is superior to any traditional solvent, by removing stains rather than spreading.

Even if the quality of wet cleaning has improved since the early 1990s, modern wet cleaning compositions and methods still provoke damage to garments in form of color loss and dimensional changes such as shrinkage.

To avoid or reduce the risk of shrinkage, cleaning is classically conducted in low water temperature inducing poor cleaning results particularly regarding oil and oil-soluble stains that can not be removed.

Low temperature and low water volume in a wet cleaning process make removal of non-polar-, solid- and not water soluble stains like deodorant and perspiration stains a very challenging task.

At the opposite, solvent-based dry cleaning processes are quite effective for removing oily soils and stains.

By definition, the term “dry cleaning” has been used to describe processes for cleaning textiles using non-aqueous solvents. Dry cleaning employs solvents such as chloroethylene, 1,1,1-trichloroethane, 1,1,2-trichloro-1,2,2-trifluoroethane, the most common and used solvent being perchloroethylene, commonly known as “perc”.

Perchloroethylene has the advantage of being stable, non flammable, and having excellent cleaning capabilities. Most of fabrics having a tendency to shrink by contact of water, or fabrics which are judged to be too valuable or delicate to be subjected to aqueous laundering processes, are dry cleaned. Thus, sensitive items including garments and fabrics made of hair, silk, rayon, animal hair, animal skin and mixed spun materials, are conventionally dry cleaned.

Perchloroethylene and other chlorine-based solvents present environmental problems (ozone layer destruction, ground-water pollution) and have been associated with health disorders that have restricted the practice of dry cleaning to commercial establishments. In recent years, the industry has responded with less-toxic alternatives to perchloroethylene, including hydrocarbons (EcoSolv™ drycleaning fluid from CPChem) and glycol ethers (U.S. Pat. No. 5,888,250; U.S. Pat. No. 6,156,074; U.S. Pat. No. 6,273,919 and U.S. Pat. No. 6,350,287 from Rynex Holdings Ltd.) used alone or in combination with other components like polysulfonic acid (U.S. Pat. No. 6,086,634; U.S. Pat. No. 6,036,727; GreenEarth). While they do have lower toxicity, siloxanes have relatively low cleaning power and are preferably avoided.

At the end, dry cleaning with various solvents are not optimal for removing particulates such as clay soils and have a very limited ability to dissolve water hence removal of water soluble stains like salt, sugar and particular water-soluble salt-containing contaminants, such as perspiration.

These particular stains pose a great challenge to the cleaning operators. To reinforce conventional laundry and dry cleaning processes, spot removal compositions or prespotting agents have been developed which involve the application of cleaning ingredients prior of cleaning process, directly to a specific spot or stain, usually with brisk manual agitation instead of total immersion of fabrics into aqueous or non-aqueous baths. Traditional spot remover compositions are typically formulated as sticks or sprays, and can comprise a variety of cleaning ingredients, including some solvents.

Performance of these spot cleaning compositions is known to vary considerably, based upon the types of stains which are to be removed as well as on the type of textiles from which the garments are made. While known spot cleaning compositions are effective for many types of stains, they are not effective in the removal of deodorant, perspiration and ink stains, both of which are notoriously difficult to remove. Modern prespotting agents do not have the ability to remove perspiration stains for example because of existing aluminum based complexes and polymers as well as stains caused by 3-ethyl-2-hexenoic acid produced by bacteria and fermentation of sweat.

For proper and efficient results, usage of spot cleaning compositions must also take in account other parameters:
Mechanical actions in prespotting processes often cause deterioration and discoloration to the surface of the fibers. Spot removal cleaning compositions have to contain ingredients selected and formulated to minimize dye removal from the fabrics being cleaned. In this regard, it is recognized that the solvents typically used in immersion cleaning processes can remove some portion of certain types of dyes from certain types of fabrics. If such removal is tolerable in immersion processes since the dye is removed relatively uniformly across the surface of the fabric, it is unacceptable that high concentrations of certain types of cleaning ingredients at specific sites on fabric surfaces can result in localized dye removal.
Repeated laundering of fabrics and textiles, especially with bleach-containing laundry products, can remove dye from fabrics and textiles and impart a faded, worn out appearance as a result of diminished color intensity, and in many cases, as a change in hues and shades of color. Stain removal methods typically employ concentrated detergent compositions that, while generally good for removing stains, require that the clothes be further processed, for example, by washing, to remove the detergent composition. Therefore a second washing cycle is often required when stains are not detected until after they have been laundered. While re-washing wastes time and resources, it is well-known and recognized that laundering operation itself, over many cycles, can accentuate and contribute to the deterioration and appearance of such fabrics and textiles. Deterioration of fabric integrity and appearance can manifest itself in several ways. Short fibers can be dislodged from woven and knit fabric/textile structures by the mechanical action of laundering. These dislodged fibers may form lint, fuzz or “pills” which are visible on the surface of the fabrics and diminish the appearance of newness of the fabric.
Numerous compositions contain alkaline or bleaching agents (U.S. Pat. No. 7,109,157). Even diluted, bleaching agents will disintegrate the fabric. Moreover, even after lengthy soaking, a dark residual stain may still remain on the fabric, even when scrubbing. Vigorous scrubbing accelerates the deterioration of the bleach-weakened fibers.

The problems described above are especially acute with sensitive fabrics, such as silk, linen, wool and other delicate fabrics.

This is an object of the present invention to overcome these shortcomings and to propose compositions and methods for removing stains, particularly deodorant, perspiration and ink stains from all kinds of fabrics including water-sensitive protein fibers such as wool, cashmere or silk.

This is another object of the present invention to propose such compositions and methods for use in commercial wet- and dry-cleaning processes but also in classical household laundry washers.

This is another object of the present invention to propose such compositions and methods usable in a single cycle cleaning process whereby the garments are treated with the compositions of the present invention, used as prespotting agents, and subsequently cleaned at low temperature either in professional wet- or dry cleaning process either in a household process.

### SUMMARY OF THE INVENTION

The present invention proposes compositions and methods to use them to solve the removal of stains and particularly those that are notoriously difficult to remove like deodorant, perspiration and ink from all kinds of garments, including water sensitive protein fibers such as wool, cashmere or silk without incurring surface damage or dye/color loss.

These compositions and methods are usable at low temperature, in a single cleaning cycle either in commercial wet- or dry cleaning processes either in household laundry processes.

The compositions and methods of the present invention allow to overcome the shortcomings of wet- and dry cleaning industries regarding the removal of particular stains by total immersion of the fabrics in aqueous or non aqueous bath.

The compositions and methods of the present invention allow to overcome the shortcomings of wet- and dry cleaning industries regarding the removal of particular stains by usage of prespotting agents. Particularly, the compositions of the present invention do not employ alkaline or bleaching agents.

The compositions of the present invention are preferentially applied as spot cleaning compositions to the stained area of garments without scrubbing before a unique cleaning cycle in a professional wet- or dry cleaning process or a regular household laundry cycle.

In a general embodiment, the present invention that will be detailed below proposes a method for removing stains and particularly those that are notoriously difficult to remove like deodorant, perspiration and ink, from all kinds of garments, including water sensitive protein fibers such as wool, cashmere or silk without incurring surface damage or dye/color loss comprising the steps of applying a spot cleaning composition to the stained area of garments without scrubbing and washing the garments in a one cycle cleaning process at any temperature from 15° C. to 40° C. The present invention also proposes a spot cleaning composition for commercial wet- and dry cleaning processes or household laundry processes useful to remove stains and particularly those that are notoriously difficult to remove like deodorant, perspiration and ink, from all kind of garments, including water sensitive protein fibers such as wool, cashmere or silk without incurring surface damage or dye/color loss, comprising :

Compositions allowing to carry out the method of the present invention contains water, an alcohol present at a volume ranging from 1% to 40% of the total volume of the compositions, a mixture of anionic surface active components present at a volume ranging from 0.1% to 10% of the total volume of the compositions, and a mixture of non anionic surface active components present at a volume ranging from 1% to 40% of the total volume of the compositions.

More particularly, alcohols entering in the compositions are selected amongst the alcohols of the formula Cn H2n+1 OH where n is 1, 2, 3 or 4. The mixture of anionic surface active components is composed of isopropylamine salts of a mixture of linear alkylbenzene sulfonic acids wherein the alkyl groups contain from 7 to 14 carbon atoms. About 19 to 24% of the linear alkylbenzene sulfonic acid salt have the benzene sulfonic acid in position 2 of the alkyl group. The mixture of non anionic surface active components is composed of a group consisting of non-ionic primary alcohol alkoxylate wherein high linear primary alcohol represents 75-85% and contain even and odd numbered carbon chain in sub 20. Preferably, non ionic primary alcohol alkoxylate is an ethoxylate alcohol with carbon atoms chain between 8 to 18 carbon atoms.

In a first aspect, the method of the present invention is appropriate for cleaning such stains from all kinds of garments in one cycle of a professional wet cleaning process at low temperature after applying, without scrubbing, the described spot cleaning compositions of the invention.

In a second aspect, the method of the present invention is appropriate for cleaning such stains from all kinds of garments in one cycle of a professional dry cleaning process at low temperature after applying, without scrubbing, the described spot cleaning compositions of the invention.

In a third aspect, the method of the present invention is appropriate for cleaning such stains from all kinds of garments in one cycle of a regular household laundry process at low temperature after applying, without scrubbing, the described spot cleaning compositions of the invention.

### DETAILED DESCRIPTION OF THE INVENTION

The present invention relates to compositions and methods to efficiently remove stains, particularly deodorant, perspiration and ink stains from all kinds of garments, including water sensitive protein fibers without incurring surface damage or dye/color loss.

By delicate or sensitive garments or water sensitive protein fibers is meant especially sensitive protein-fibers such as wool, cashmere and silk, but also fabrics made of hair, silk, rayon, animal hair, animal skin and mixed spun materials.

By cleaning or washing herein is meant removal of soils and stains from fabrics. The different kinds of dirt occurring in textiles can be subdivided into water-soluble dirt and water insoluble dirt that partly consists of suspendable or emulsifiable dirt. Water-soluble dirt comprises for example sugars, acids, salts and urea; water-insoluble dirt comprises for example sand, clay, proteins, fats, oils, soot, dyes and microorganisms. Suspendable and emulsifiable dirt comprises, inter alia, proteins, starch, foods, fats, oils, and blood constituents. By cleaning or washing herein is also meant removing of odors and smoke but also fire restoration.

The present invention is particularly dedicated to the removal of stains notoriously known as difficult to remove like perspiration, deodorant, ink stains. By perspiration stains, is meant all kinds of perspiration stains. By deodorant stains is meant also antiperspirant and perfume stains. By ink stains is meant all kinds of ink stains from liquid, powder and permanent ink origins.

By surface damages and dye/color loss is meant deterioration of fabrics integrity and appearance that can manifest itself in several ways. Short fibers are dislodged form woven and knit fabric/textile structures by the mechanical action of laundering. These dislodged fibers may form lint, fuzz or pills which are visible on the surface of fabrics and may diminish the appearance of newness of the fabric. Further repeated laundering of fabrics can remove dye from them and impart a faded appearance, as a result of diminished color intensity and in many cases, as a result of changes in hues or shades of color.

By spot cleaning compositions is meant a local application of cleaning ingredients in contrast to total immersion processes of fabrics into aqueous or non-aqueous baths. In this definition is also comprised synonyms like prespotting agents, prespotting compositions, spot removal or spot remover compositions.

Spot remover compositions of the present invention could be formulated as liquids, liquid/solid sticks, sprays, gels, or as other formulations convenient to be applied on garments.

Compositions allowing to carry out the method of the present invention contains water, an alcohol present at a volume ranging from 1% to 40% of the total volume of the compositions. Alcohols entering in the compositions are selected amongst the alcohols of the formula Cn H2n+1 OH where n is 1, 2, 3 or 4, i.e methanol, ethanol, propanol, isopropanol and butanol. Said compositions also contain a mixture of anionic surface active components present at a volume ranging from 0.1% to 10% of the total volume of the compositions. The mixture of anionic surface active components is composed of isopropylamine salts of a mixture of linear alkylbenzene sulfonic acids wherein the alkyl groups contain from 7 to 14 carbon atoms. Alkylbenzene sulfonic acids are components in which the alkyl group contains from 7 to 14 carbon atoms, is in straight or branched chain configuration. About 19 to 24% of the linear alkylbenzene sulfonic acid salt have the benzene sulfonic acid in position 2 of the alkyl group. Said compositions also contain a mixture of non anionic surface active components present at a volume ranging from 1% to 40% of the total volume of the compositions. The mixture of non anionic surface active components is composed of a group consisting of non-ionic primary alcohol alkoxylate wherein high linear primary alcohol represents 75-85% and contain even and odd numbered carbon chain in sub 20. Non ionic primary alcohol alkoxylate is preferably an ethoxylate alcohol with carbon atoms chain between 8 to 18 carbon atoms.

The present invention involves a unique cycle cleaning process whereby the garments are treated with the compositions of the present invention as prespotting agents, without scrubbing, and subsequently cleaned at low temperature either in a professional wet cleaning or dry cleaning process either in a household process.

By low temperature is meant any temperature from 15° C. to 40° C., preferably 15° C. to 30° C., more preferably 25° C.

The present invention also relates to methods allowing to use the compositions of the invention.

In a first aspect, the present invention is appropriate for cleaning stains, particularly those which are known to be difficult to remove like perspiration, deodorant and ink stains, from all kinds of garments in one cycle of a professional wet cleaning process after applying the described spot cleaning compositions of the invention.

By professional wet cleaning cycle is meant different steps in a wet cleaning washer composed of a washing step, a rinsing step in a preconditioning solution and a rinsing step in a conditioning solution. By washing step is meant a step in the presence of the compositions of the present invention for a time duration in the range of 1 to 15 minutes, preferably in the range of 3 to 12 minutes, at a temperature in the range of 15° C. to 40° C., preferably 15° C. to 30° C. By rinsing step in a preconditioning solution is meant a step in the presence of a preconditioner as defined below for a time duration in the range of 2 to 4 minutes, at a temperature in the range of 15° C. to 40° C., preferably 15° C. to 30° C. By rinsing step in a conditioning solution is meant a step in the presence of a conditioner as defined below for a time duration in the range of 2 to 10 minutes, at a temperature in the range of 15° C. to 40° C., preferably 15° C. to 30° C. Washing and preconditioning steps are respectively followed by draining/extracting steps at 500 rpm for a time duration in a range of 0.5 to 2 minutes, preferably 1 minute. Conditioning step is followed by a draining/extracting step at 1,000 rpm for a time duration of 1 to 8 minutes, preferably 4 minutes.

By the terms preconditioning/preconditioner or conditioning/conditioner are meant products or compositions intended to be used by being diluted with water to produce a liquor suitable for treating textiles/garments and conferring to them one or more conditioning benefits known to those skilled in the art. They can be used in a number of purposes as compositions combining softeners/detergent in final rinse of a washing cycle, for example, to confer conditioning benefits to garments and textiles. In general, preconditioners and conditioners are respectively used successively, the action of the first one preparing/improving the action of the second one. Depending on the washed textiles and the cleaning processes, they can be used to avoid drawbacks classically associated to dry- or wet cleaning processes, like dimensional changes, shrinkage, surface damages, dye or color loss associated to garments and particularly to sensitive garments made of water-sensitive protein fibers such as wool, cashmere or silk, for example.

In a second aspect, the present invention is appropriate for cleaning stains, particularly those which are known to be difficult to remove like perspiration, deodorant and ink stains, from all kinds of garments in one cycle of a professional dry cleaning process after applying, without scrubbing, the described spot cleaning compositions of the invention.

By professional dry cleaning cycle is meant a washing step in a dry cleaning commercial washer for a time duration corresponding to a normal cycle in the range of 2 to 10 minutes, preferably 7 minutes, followed by a draining/extracting step for a time duration in the range of 1 to 8 minutes, preferably 4 minutes, a drying step in the range of temperatures of 50° C. to 60° C., preferably 55° C. and a cool down step.

In a third aspect, the present invention is appropriate for cleaning stains, particularly those which are known to be difficult to remove like perspiration, deodorant and ink stains, from all kinds of garments in one cycle of a regular household laundry process after applying, without scrubbing, the described spot cleaning compositions of the invention.

The spot cleaning compositions of the present invention have been designed to optimise spot removals of stains, particularly deodorant, perspiration and ink stains, from all kinds of garments, including sensitive garments in professional or household equipment to avoid surface damages and color loss. It is understood that the compositions of the present invention are particularly well-suited for the methods previously described in the present invention. It is also understood that these compositions could be independently used in other spot removals/cleaning processes dedicated to clean garments in professional or household equipment without surface damages and color loss. It should be also understood that the prespotting compositions of the present invention could be used in association with every washing or preconditioning or conditioning compositions used in the art of fabrics for cleaning in professional or household equipment. It should be understood that the prespotting compositions of the present invention could be used in other washing, preconditioning and conditioning methods and process of the art of fabrics for cleaning with professional or household equipment.

Several examples are given below to explain and illustrate the invention, but the scope of the present invention has not to be limited to these examples.

### EXAMPLES

Regular test, Wet-Cleaning:
1. Seven pieces of different silk and cotton garments of various manufacturers with perspiration, deodorant and ink stains were selected.
2. In a first step, the garments were prespotted with the solution described in the present invention, and introduced in a 55 lb. commercial wet-cleaning washer (brand: IMESA), washed for 7 minutes at 25° C. The aqueous solution was drained and extracted for 1 minute at 500 rpm.
3. In a second step the garments were rinsed for 4 minutes at 25° C. with a preconditioning solution. The aqueous solution was drained and extracted for 1 minute at 500 rpm.
4. In a third step the garments were rinsed for 7 minutes at 25° C. with a conditioning solution. The aqueous solution was drained and extracted for 4 minutes at 1000 rpm.
5. In a fourth step the garments were dried in a 75 lb. commercial dryer (Brand: IMESA) to a moisture level of 15%.

Subsequent assessment revealed that the garments are completely free of perspiration, deodorant and ink stains. No dye/color losses could be determined.

Regular test, Dry-Cleaning:
1. Seven wool and silk garments of various manufacturers with perspiration, deodorant and ink stains were selected.
2. In a first step, the garments were prespotted with the solution described in the present invention and introduced in a Multimatic 60 lb. commercial perchloroethylene dry-cleaning machine in a normal cycle (washed for 7 minutes). The solvent was drained and extracted for 4 minutes.
3. In a second step the garments were dried at 55° C.
4. In a third step, after a cool down cycle completed, the garments were removed.

Subsequent assessment revealed that the garments are completely free of perspiration, deodorant and ink stains. No dye/color losses could be determined.

Regular test, Laundry:
1. Seven washable garments of different types and of various manufacturers with perspiration, deodorant and ink stains were selected.
2. In a first step, the garments were prespotted with the solution described in the present invention and introduced in a 6 kg. Miele laundry washer and washed in a 30° C. cycle.
3. In a second step, the garments were dried in a 6 kg. Miele dryer.

Subsequent assessment revealed that the garments are completely free of perspiration, deodorant and ink stains. No dye/color losses could be determined.

Comparison test Dry-Cleaning:
1. Fourteen woolen and silk garments of various manufacturers with perspiration, deodorant and ink stains were selected.
2. In a first step, the garments were prespotted with two different commercially available prespotting products and introduced in a Multimatic 60 lb. commercial perchloroethylene dry-cleaning machine in a normal cycle (washed for 7 minutes). The solvent was drained and extracted for 4 minutes.
3. In a second step the garments were dried at 55° C.
4. In a third step, after a cool down cycle was completed, the garments were removed.

Subsequent assessment has shown that most garments had still noticeable perspiration, deodorant and ink stains, dye/color losses. Three of silk garments were damaged.

Comparison test Wet-Cleaning:
1. Fourteen pieces of different silk garments of various manufacturers with perspiration, deodorant and ink stains were selected.
2. In a first step, the garments were prespotted with the two different commercially available prespotting solution and introduced in a 55 lb. commercial wet-cleaning washer (brand: IMESA), washed for 7 minutes at 25° C. The aqueous solution was drained and extracted for 1 minute at 500 rpm.
3. In a second step the garments were rinsed for 4 minutes at 25° C. with a preconditioning solution. The aqueous solution was drained and extracted for 1 minute at 500 rpm.
4. In a third step the garments were rinsed for 7 minutes at 25° C. with a conditioning solution. The aqueous solution was drained and extracted for 4 minutes at 1000 rpm.
5. In a fourth step, the garments were dried in a 75 lb. commercial dryer (brand: IMESA) to a moisture level of 15%.

The cleaned garments were assessed for the cleaning and stains. All silk garment had still some stains and five items revealed visible surface and color changes.

1. A method for removing stains and particularly those that are notoriously difficult to remove like deodorant, perspiration and ink, from all kinds of garments, including water sensitive protein fibers such as wool, cashmere or silk without incurring surface damage or dye/color loss comprising the steps of:
a) applying a spot cleaning composition to the stained area of garments without scrubbing wherein the spot cleaning composition comprises:
1) water;
2) an alcohol present at a volume ranging from 1% to 40% of the total volume of the composition;
3) anionic surface active components mixture present at a volume ranging from 0.1% to 10% of the total volume of the composition; and
4) non anionic surface active components mixture present at a volume ranging from 1% to 40% of the total volume of the composition; and
b) washing the garments in a one cycle cleaning process at any temperature from 15° C. to 40° C.

2. A method according to claim 1 wherein said alcohol is selected from the alcohols of the formula Cn H2n+1 OH where n is 1, 2, 3 or 4.

3. A method according to claim 1 wherein said anionic surface active components are isopropylamine salts of a mixture of linear alkylbenzene sulfonic acids wherein the alkyl groups contain from 7 to 14 carbon atoms and about 19 to 24% of the linear alkylbenzene sulfonic acid salt have the benzene sulfonic acid in position 2 of the alkyl group.

4. A method according to claim 1 wherein said non anionic surface active components are selected from a group consisting of non-ionic primary alcohol alkoxylate wherein high linear primary alcohol represents 75-85% and contain even and odd numbered carbon chain in sub 20.

5. A method according to claim 4 wherein said non ionic primary alcohol alkoxylate is an ethoxylate alcohol with carbon atoms chain between 8 to 18 carbon atoms.

6. A method according to claim 1, wherein the spot cleaning composition is applied to the stained area of the garments without scrubbing and the garments are wet-cleaned in a wet cleaning washer in one cycle according to the type of fibers.

7. A method according to claim 1, wherein the spot cleaning composition is applied to the stained area of the garments without scrubbing and the garments are dry-cleaned in a normal dry cleaning cycle.

8. A method according to claim 1, wherein the spot cleaning composition is applied to the stained area of the garments without scrubbing and the garments are washed in a regular laundry cycle.

9. A spot cleaning composition for commercial wet- and dry cleaning processes or household laundry processes useful to remove stains and particularly those that are notoriously difficult to remove like deodorant, perspiration and ink, from all kinds of garments, including water sensitive protein fibers such as wool, cashmere or silk without incurring surface damage or dye/color loss, comprising:
a. water;
b. an alcohol present at a volume ranging from 1% to 40% of the total volume of the composition;
c. anionic surface active components mixture present at a volume ranging from 0.1% to 10% of the total volume of the composition; and
d. non anionic surface active components mixture present at a volume ranging from 1% to 40% of the total volume of the composition.
